(19) United States
(12) Patent Application Publication
(10) Pub. No.: US 2020/0233570 A1
(43) Pub. Date: Jul. 23, 2020

(54) DISPLAY CONTROL DEVICE, DISPLAY CONTROL METHOD, NON-TRANSITORY COMPUTER-READABLE RECORDING MEDIUM, AND ELECTRONIC DEVICE

(71) Applicant: Mitsubishi Electric Corporation, Tokyo (JP)

(72) Inventor: Takayasu HASHIMOTO, Tokyo (JP)

(73) Assignee: Mitsubishi Electric Corporation, Tokyo (JP)

(21) Appl. No.: 16/839,217

(22) Filed: Apr. 3, 2020

Related U.S. Application Data
(63) Continuation of application No. PCT/JP2017/036770, filed on Oct. 11, 2017.

(51) Int. Cl. G06F 3/0484; G06F 3/0482; G06F 3/0362

(52) U.S. Cl. CPC G06F 3/04845; G06F 3/0362; G06F 3/0482

(57) ABSTRACT

Included are a list display instructor for causing a display to display an at-a-glance list including a plurality of items representing information to be provided to a user; a position acquisitor for acquiring a position of an input unit movably provided on the display; a size controller for calculating an amount of alteration in size of a display region of each item in the list displayed on the display in response to change in position of the input unit when the position of the input unit, which has been acquired by the position acquisitor, is changed; and a display alteration instructor for altering the size of a display region of each item in the list displayed on the display on the basis of the calculated amount of alteration in size of the display region of each item.

### CROSS REFERENCE TO RELATED APPLICATIONS

This application is a Continuation of PCT International Application No. PCT/JP2017/036770, filed on Oct. 11, 2017, all of which is hereby expressly incorporated by reference into the present application.

### TECHNICAL FIELD

The present invention relates to a display control device, a display control method, a non-transitory computer-readable recording medium, and an electronic device for displaying a list on a display unit.

### BACKGROUND ART

In a display method for displaying a list containing a plurality of items on a display unit, when the number of items displayed on a display unit at a time is increased to ensure at-a-glance readability of the list, the display region of each item is narrowed, and information, on each item, capable of being displayed in the display region is limited. In contrast, when the display region of each item displayed in a list is widened to reduce the limitation on information, on each item, capable of being displayed in the display region, the number of items displayed on the display unit at one time is reduced, and the at-a-glance readability cannot be ensured.

Therefore, in a traditional list display method, a screen in which the display region of each item is narrowed and the at-a-glance readability has priority, a screen in which the display region of each item is widened and priority is given to reducing limitations on information, on each item, capable of being displayed, and, as necessary, one or a plurality of screens having an intermediate size of the display region are preset so as to mutually have a hierarchical relation, and a plurality of screens are switched and displayed in response to user operations.

As a technique for altering the size of a plurality of display regions in a display unit, for example, Patent Literature 1 discloses an input display device that alters the size of each display region divided into an upper part and a lower part by vertically moving a slide member. The slide member is a horizontally long guide bar that connects a right side and a left side of a touch panel disposed in a vertically long manner so as to divide the display region of a screen into an upper part and a lower part.

### CITATION LIST

### Patent Literatures

Patent Literature 1: JP 2016-206930 A

### SUMMARY OF INVENTION

### Technical Problem

In a traditional list display method, a user needs to perform an operation of switching a screen each time the user changes the size of a display region of each item displayed in a list. For this reason, in the traditional list display method, when the number of screens, in which the display regions of items have different sizes, is increased, the user can finely select the size of a display region, but unfortunately, the number of user operations required for switching is increased.

The input display device disclosed in Patent Literature 1 changes the size of a display region of a screen itself that has been divided into upper and lower parts by vertically moving a slide member. However, the sizes of the display regions of a plurality of items in the list when the list is displayed in the display region are not considered.

The invention has been made to solve the above-described problems, and an object thereof is to provide a display control device capable of altering the size of a display region for each of a plurality of items displayed in a list with a simple operation.

### Solution to Problem

A display control device according to the invention includes processing circuitry to: cause a display to display an at-a-glance list including a plurality of items representing information to be provided to a user, acquire a position of an input unit movably provided on the display, calculate an amount of alteration in size of a display region of each item in the list displayed on the display in response to change in position of the input unit when the acquired position of the input unit is changed, alter the size of a display region of each item in the list displayed on the display on a basis of the calculated amount of alteration in size of the display region of each item, and determine whether the acquired position of the input unit is at an operation guide display position, wherein, when the processing circuitry determines that the input unit is at the operation guide display position, the processing circuitry causes the display to display a prospective operation content to be executed next.

### Advantageous Effects of Invention

According to the invention, the size of a display region for each of a plurality of items displayed in a list can be altered by the smaller number of operations than in traditional list display methods.

### BRIEF DESCRIPTION OF DRAWINGS

FIG. 1 illustrates one example of the outline of an electronic device mounted with a display control device according to a first embodiment.

FIG. 2 illustrates one example of the configuration of the display control device according to the first embodiment.

FIG. 3 is a flowchart for describing operations of the display control device of the first embodiment.

FIG. 4 illustrates one example of a display unit in a state where a list display instruction unit causes information on a guide route to a destination set by a user to be displayed in the first embodiment.

FIGS. 5A and 5B illustrate one example of images of a list displayed on the display unit in the case where the operations of Steps ST304 to ST311 in FIG. 3 are performed in the first embodiment, FIG. 5A illustrates one example of images of the display unit in a state where a menu is displayed on the display unit as a result of the user gripping an input unit and the input unit is at the origin, and FIG. 5B illustrates one example of images of the display unit in a state where the input unit has been moved from the state of FIG. 5A to the right.

FIGS. 6A and 6B illustrate one example of images of a list displayed on the display unit in the case where the display control device continuously alters the size of a display region for information on each item in a list and the amount of information to be displayed on the display region in response to the change in position of the input unit in the first embodiment, FIG. 6A illustrates an image of one example of specific contents displayed on the display unit, and FIG. 6B illustrates an image of the shape of a display region altered along with the size.

FIG. 7 illustrates one example of images of a list displayed on the display unit in the case where the display control device alters the size of a display region for information on each item in the list and the amount of information to be displayed on the display region in a limited manner in three stages in response to the change in position of the input unit in the first embodiment.

FIGS. 8A and 8B illustrate examples of the hardware configuration of the display control device according to the first embodiment.

FIG. 9 illustrates one example of the configuration of a display control device according to a second embodiment.

FIG. 10 is a flowchart for describing operations of the display control device of the second embodiment.

FIGS. 11A to 11C illustrate one example of images of a screen on which a display alteration instruction unit causes a display unit to display an operation guide in the second embodiment, FIG. 11A illustrates one example of images of a list displayed on the display unit before an input unit is moved to an operation guide display position, FIG. 11B illustrates one example of images of a screen of the display unit at the time when the input unit is moved from the state illustrated in FIG. 11A to the operation guide display position, and FIG. 11C illustrates one example of images of a screen of the display unit at the time when the input unit is further moved from the state illustrated in FIG. 11B to a screen switching position.

FIG. 12 illustrates one example of screen transition operations performed in the case where the input unit is moved to the left in the second embodiment.

FIGS. 13 A to 13D illustrates one example of images of a screen of the input unit in the case where the display alteration instruction unit causes the operation guide to be displayed in stages in the second embodiment, FIG. 13A illustrates one example of images of a screen of the display unit in the case where the input unit is at the operation guide display position, and FIGS. 13B and 13C illustrate examples of images of a screen of the display unit in the case where the input unit is positioned between the operation guide display position and the screen switching position. FIG. 13D illustrates one example of images of a determination screen in the case where the input unit is at the screen switching position.

FIG. 14 illustrates one example of the configuration of a display control device according to a third embodiment.

FIG. 15 is a flowchart for describing operations of the display control device of the third embodiment.

FIGS. 16A and 16B illustrate an image of an operation in which a cursor is moved in the amount of movement of the cursor calculated by a cursor control unit on the basis of the movement threshold that has been changed by a movement threshold alteration unit in the third embodiment, FIG. 16A illustrates one example of images of the cursor movement in the case where the cursor is moved in a state where the input unit is moved from the origin to the left, and FIG. 16B illustrates one example of images of the cursor movement in the case where the cursor is moved in a state where the input unit is moved from the state in FIG. 16A to a position on the right of the origin.

### DESCRIPTION OF EMBODIMENTS

In order to describe the invention in more detail, embodiments for carrying out the invention will be described below with reference to the accompanying drawings.

### First Embodiment

A display control device according to a first embodiment is mounted in, for example, an electronic device installed in a center console of a vehicle such as an automobile. The center console is provided in a front part of the vehicle interior. Note that this is only one example. The display control device is not limited to being mounted in an electronic device installed in the vehicle interior, but can be mounted in various electronic devices that perform display.

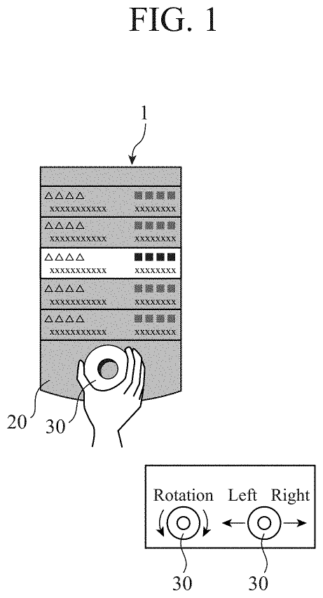

FIG. 1 illustrates one example of the outline of an electronic device 1 mounted with a display control device 10 according to the first embodiment. Note that the display control device 10 is not illustrated in FIG. 1. The detailed configuration of the display control device 10 will be described later.

The electronic device 1 includes a display unit 20 and an input unit 30.

The display unit 20 is, for example, a touch panel display. The display unit 20 displays, for example, a guide route to a destination set by a user. For example, a navigation device (not illustrated) searches for the guide route, and the guide route is displayed on the display unit 20. Furthermore, when there is information, for example, information about a recommended restaurant on the route, to be provided to a user, a list of a plurality of items representing the information to be provided to the user is displayed on the display unit 20.

The input unit 30 is provided on the display unit 20 so as to be movable in a preset movable range. In the first embodiment, the input unit 30 linearly moves to the right and left with respect to the display unit 20 in the movable range.

Furthermore, the input unit 30 has a shape that can be grasped by the user. As illustrated in FIG. 1, the input unit 30 is substantially circular in the first embodiment. Note that, although the input unit 30 is substantially circular here as illustrated in FIG. 1, the input unit 30 as illustrated in FIG. 1 is only one example. The input unit 30 is only required to have a shape that is easily grasped and rotated by the user.

Furthermore, the input unit 30 is provided on the display unit 20 so as to be rotatable about a rotation axis, serving as a rotation center, extending in a direction perpendicular to the surface of the display unit 20. In the first embodiment, being vertical includes being substantially vertical.

The input unit 30 is movably provided on the display unit 20 by an appropriate method. For example, a slide guide unit for guiding a movement of the input unit 30 is provided on the display unit 20, and the input unit 30 is required to move on the slide guide unit. The structure for movably providing the input unit 30 on the display unit 20 is required to be appropriately achieved by known techniques.

The user instructs the display unit 20 to display various pieces of information by gripping the input unit 30 and moving or rotating the input unit 30. Specific operations will be described later.

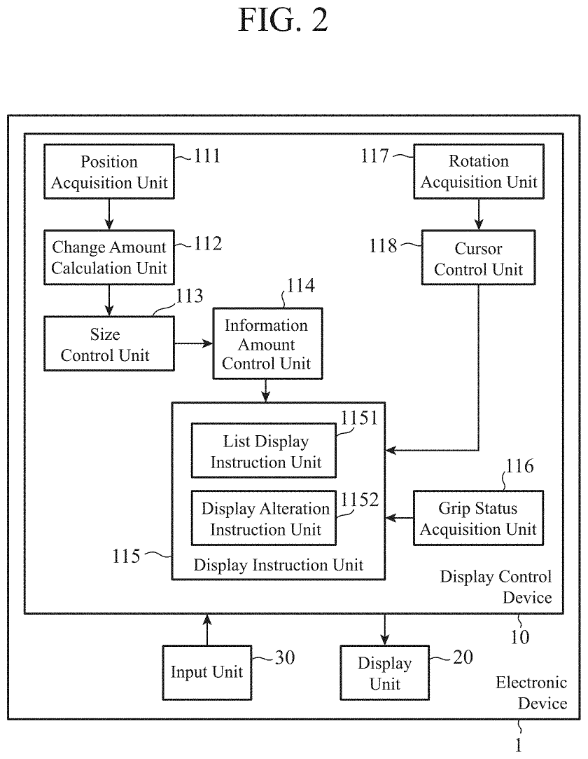

FIG. 2 illustrates one example of the configuration of the display control device 10 according to the first embodiment.

As illustrated in FIG. 2, the display control device 10 includes a position acquisition unit 111, a change amount calculation unit 112, a size control unit 113, an information amount control unit 114, a display instruction unit 115, a grip status acquisition unit 116, a rotation acquisition unit 117, and a cursor control unit 118. The display instruction unit 115 includes a list display instruction unit 1151 and a display alteration instruction unit 1152.

The position acquisition unit 111 acquires the current position of the input unit 30 in the movable range of the input unit 30. In the following description, the current position of the input unit 30 acquired by the position acquisition unit 111 is also simply referred to as the position of the input unit 30.

In the first embodiment, the position of the input unit 30 refers to the current position of the rotation center of the input unit 30. Furthermore, a line segment drawn by a locus along which the rotation center of the input unit 30 passes is defined as an X-axis. The input unit 30 moves in the movable range. The position of the substantial midpoint of the X-axis is defined as the origin.

The position of the input unit 30 acquired by the position acquisition unit 111 is represented by a coordinate x. The coordinate x indicates the position of each of a plurality of pixels at a part overlapping the X-axis among a plurality of pixels constituting the display unit 20. The coordinate x is a coordinate using one pixel as a unit.

For example, when the input unit 30 moves from the origin (x=0) to the right with respect to the display unit 20, the x-coordinate indicating the position of the input unit 30 is positive. Furthermore, for example, when the input unit 30 moves from the origin (x=0) to the left with respect to the display unit 20, the x-coordinate indicating the position of the input unit 30 is negative.

The input unit 30 is positioned at the origin, for example, in a state where the user is not operating the input unit 30 (see FIG. 1). The input unit 30 is configured to automatically return to the position of the origin when, for example, the user operates the input unit 30 to move the input unit 30 to the right or left and releases his/her hand at the moved position.

The position acquisition unit 111 outputs the acquired position information of the input unit 30 to the change amount calculation unit 112.

The change amount calculation unit 112 determines whether the position of the input unit 30 has been changed on the basis of the position information of the input unit 30 output from the position acquisition unit 111, and when the position of the input unit 30 has been changed, the change amount calculation unit 112 calculates an amount of change in position of the input unit 30. As described above, the coordinate x indicating the position of each pixel on the X-axis represents the position of the input unit 30, and the change amount calculated by the change amount calculation unit 112 corresponds to the difference between a value of the x-coordinate at the position of the input unit 30 before movement and a value of the x-coordinate at the position of the input unit 30 after movement on the X-axis.

The change amount calculation unit 112 outputs the calculated change amount to the size control unit 113.

The size control unit 113 calculates an amount of alteration in size of a display region of each item in a list displayed on the display unit 20 on the basis of the change amount calculated by the change amount calculation unit 112.

In the first embodiment, the size of a display region of each item in the list can be altered in the vertical direction of the display region. The vertical direction is orthogonal to the X-axis on the surface of the display unit 20. In the following description, the vertical direction is referred to as a Y-axis direction. In such a way, in the first embodiment, the movement direction (X-axis direction) of the input unit 30 and the alteration direction (Y-axis direction) in which the size of a display region of each item in the list is altered are orthogonal on the display unit 20. Note that, in the first embodiment, being orthogonal includes being substantially orthogonal.

The size control unit 113 calculates an amount of alteration in width in the Y-axis direction of the display region of each item in the list as the amount of alteration in size of a display region. In the first embodiment, the size control unit 113 calculates an amount of alteration in width of the display region in the Y-axis direction with a value using one pixel as a unit.

The size control unit 113 outputs the calculated amount of alteration in size of a display region to the information amount control unit 114.

The information amount control unit 114 determines an information amount alteration amount (hereinafter referred to as an “information alteration amount”) regarding information on each item, for each item in the list displayed on the display unit 20 on the basis of the amount of alteration in size of a display region calculated by the size control unit 113.

In the first embodiment, an amount of information that can be displayed on a display region of each item in the list is predetermined depending on the size of the display region of each item. The information amount control unit 114 determines information that can be added or information to be deleted in relation to information on each item in the list displayed on the display region as the information alteration amount on the basis of the amount of alteration in size of a display region calculated by the size control unit 113 and the width of the display region in the Y-axis direction before alteration.

The information amount control unit 114 outputs the determined information alteration amount to the display instruction unit 115. Note that, at this time, the information amount control unit 114 also outputs the amount of alteration in size of a display region acquired from the size control unit 113 to the display instruction unit 115.

The display instruction unit 115 causes the display unit 20 to display various pieces of information. Furthermore, the display instruction unit 115 causes the display unit 20 to display a set screen.

When the (later-described) grip status acquisition unit 116 outputs information that the input unit 30 has detected a hand of a user, the list display instruction unit 1151 of the display instruction unit 115 causes the display unit 20 to display the above-described list (see FIG. 1). Furthermore, when the grip status acquisition unit 116 outputs information that the input unit 30 has not detected the hand of the user, the list display instruction unit 1151 causes the display unit 20 to display a screen other than the above-described list. The display of a screen other than the list will be described later with a specific example.

The display alteration instruction unit 1152 of the display instruction unit 115 alters the size of the display region of each item in the list displayed on the display unit 20 on the basis of the amount of alteration in size of a display region that has been calculated by the size control unit 113. Furthermore, the display alteration instruction unit 1152 alters an amount of information to be displayed on the display region of each item in the list on the basis of the information alteration amount determined by the information amount control unit.

Furthermore, the display alteration instruction unit 1152 causes a cursor displayed by the display unit 20 to be displayed at a position to which the cursor has been moved on the basis of a cursor movement amount calculated by the (later-described) cursor control unit 118. The cursor movement will be described later.

Note that, when the size of the display region of each item in the list displayed on the display unit 20 by the display alteration instruction unit 1152 is altered, the display instruction unit 115 instructs the display unit 20 to display, for example, the item in which a cursor has been positioned before change in size on the display unit 20 even after the change in size.

The grip status acquisition unit 116 acquires information on whether the input unit 30 has detected the hand of the user. Specifically, for example, the input unit 30 includes a sensor (not illustrated) for detecting a hand of a user, and the grip status acquisition unit 116 acquires information on whether the hand of the user has been detected from the sensor. When acquiring information indicating that the hand of the user has been detected from the sensor, the grip status acquisition unit 116 determines that the user is gripping the input unit 30. In contrast, when not acquiring the information indicating that the hand of the user has been detected from the sensor, the grip status acquisition unit 116 determines that the user is not gripping the input unit 30. Note that this is only one example, and the grip status acquisition unit 116 is only required to determine whether the user is gripping the input unit 30.

The grip status acquisition unit 116 outputs information on whether the user is gripping the input unit 30 to the display instruction unit 115.

The rotation acquisition unit 117 acquires the rotation angle of the input unit 30. Specifically, for example, the input unit 30 includes a rotation sensor (not illustrated), and the rotation acquisition unit 117 acquires the rotation angle of the input unit 30 from the rotation sensor. Note that this is only one example, and the rotation acquisition unit 117 may use means other than the rotation sensor as long as the rotation angle of the input unit 30 can be acquired.

The rotation acquisition unit 117 outputs the acquired rotation angle of the input unit 30 to the cursor control unit 118. Note that the rotation acquisition unit 117 outputs information of a rotation angle “0° ” to the cursor control unit 118 even when the input unit 30 is not rotated.

The cursor control unit 118 calculates a movement amount for moving a cursor position displayed on the display unit 20 on the basis of the rotation angle of the input unit 30 acquired by the rotation acquisition unit 117. The amount of movement of the cursor position is information indicating, for example, to which side on the list and by how many items a cursor is moved from an item in which the cursor is currently positioned while using one item as a unit.

The cursor control unit 118 outputs the calculated amount of movement of the cursor position to the display instruction unit 115.

Operations of the display control device 10 of the first embodiment will be described.

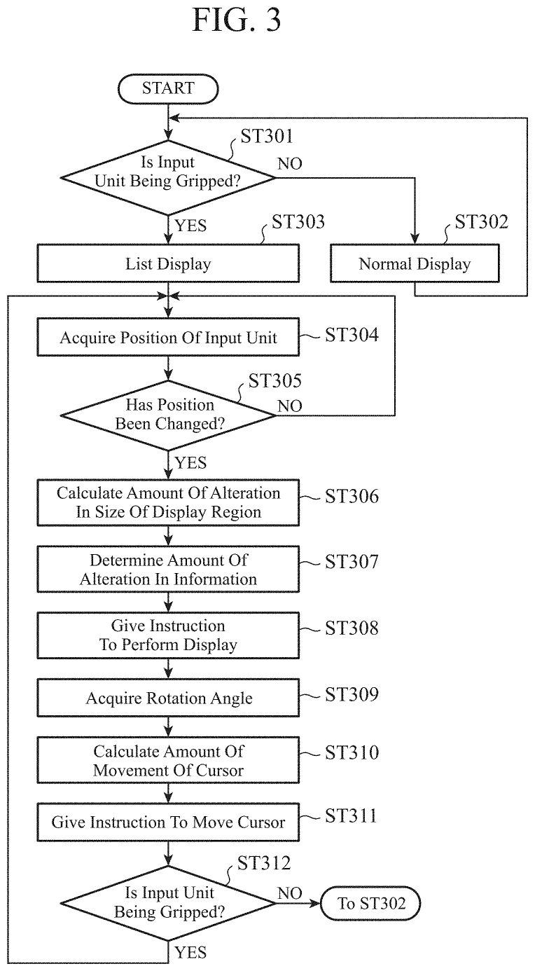

FIG. 3 is a flowchart for describing operations of the display control device 10 of the first embodiment.

The grip status acquisition unit 116 determines whether a user is gripping the input unit 30 (Step ST301).

When determining that the user is not gripping the input unit 30 in Step ST301 (“NO” in Step ST301), the grip status acquisition unit 116 outputs information indicating that the user is not gripping the input unit 30 to the display instruction unit 115.

When acquiring the information indicating that the user is not gripping the input unit 30, the list display instruction unit 1151 of the display instruction unit 115 causes the display unit 20 to perform normal display (Step ST302).

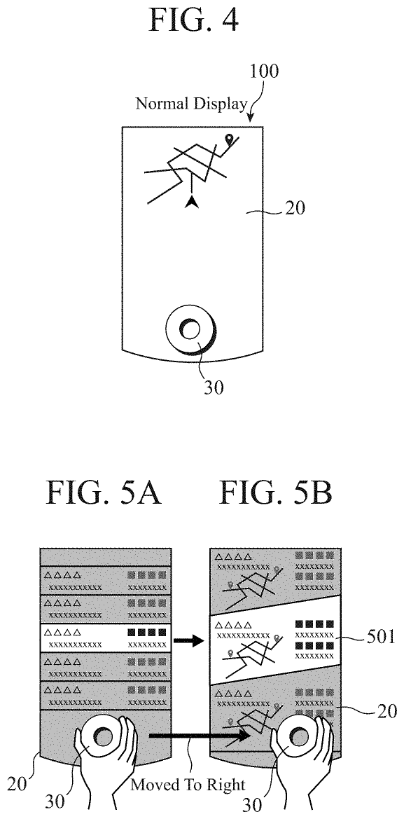

In the first embodiment, the normal display means display of a screen other than a list. The list display instruction unit 1151 acquires, for example, information on a guide route to a destination set by the user from a navigation device (not illustrated) mounted in a vehicle, and causes the display unit 20 to display the information on the guide route as normal display as illustrated in FIG. 4. Furthermore, the list display instruction unit 1151 causes the display unit 20 to display, for example, an icon of an application that can be used by the user as normal display. Note that these are only examples, and the normal display that the list display instruction unit 1151 causes the display unit 20 to display may be any screen display as long as a screen other than the list is displayed.

When determining that the user is gripping the input unit 30 in Step ST301 (“YES” in Step ST301), the grip status acquisition unit 116 outputs information indicating that the user is gripping the input unit 30 to the display instruction unit 115.

When acquiring the information indicating that the user is gripping the input unit 30, the list display instruction unit 1151 of the display instruction unit 115 causes the display unit 20 to display a list (Step ST303). In the first embodiment, examples of the list are assumed to include an at-a-glance menu list including pieces of information on recommended restaurants on the guide route. The menu list is created by preliminarily narrowing the pieces of information on recommended restaurants on the guide route down to several pieces of information by using, for example, artificial intelligence (AI). In the following description, the list displayed on the display unit 20 illustrated in FIG. 1 is, in one example, an at-a-glance menu list, for the user, including pieces of information on recommended restaurants on the guide route.

When the list is displayed, the user operates the input unit 30.

The position acquisition unit 111 acquires the position of the input unit 30 in the movable range of the input unit 30 (Step ST304).

The position acquisition unit 111 outputs the acquired position information of the input unit 30 to the change amount calculation unit 112.

The change amount calculation unit 112 determines whether the position of the input unit 30 has been changed (Step ST305).

When the position of the input unit 30 has not been changed in Step ST305 (NO in Step ST305), the processing returns to Step ST304.

When the position of the input unit 30 has been changed in Step ST305 (“YES” in Step ST305), the change amount calculation unit 112 calculates an amount of change in position of the input unit 30, and outputs the calculated change amount to the size control unit 113.

The size control unit 113 calculates an amount of alteration in size of a display region of each item in a list displayed on the display unit 20 on the basis of the amount of change in position of the input unit 30 calculated by the change amount calculation unit 112 in Step ST305 (Step ST306).

For example, when the user performs an operation of moving the input unit 30 to the right by five pixels, the change amount calculation unit 112 calculates the amount of change in position of the input unit 30 as “+5” in Step ST305. The size control unit 113 calculates an amount of alteration in width in the Y-axis direction of the display region of each item in the list in the case where the change amount of the input unit 30 is “+5” as the amount of alteration in size of the display region. Note that a formula for computation for the amount of alteration in width in the Y-axis direction with respect to the amount of change in position of the input unit 30 is predetermined. Here, when the amount of change in position of the input unit 30 is “+5”, the amount of alteration in width in the Y-axis direction of the display region of each item in the list is 10 pixels (“+10”).

The size control unit 113 outputs the calculated amount of alteration in size of a display region to the information amount control unit 114. Here, the size control unit 113 outputs the amount “+10” of alteration in size of a display region to the information amount control unit 114.

The information amount control unit 114 determines an amount of alteration in information on each item in the list displayed on the display unit 20 on the basis of the amount of alteration in size of a display region calculated by the size control unit 113 in Step ST306 (Step ST307).

For example, as illustrated in FIG. 1, a list of information on recommended restaurants is displayed. Furthermore, at this time, a name of each restaurant and a photograph of each restaurant are displayed in each item in the list as information on each restaurant.

When the size of the display region of each item is altered by “+10” from this state, the information amount control unit 114 determines that route information to a restaurant can be displayed in addition to the restaurant name and the photograph of the restaurant. That is, the information amount control unit 114 determines the route information to the restaurant as information that can be added.

Note that the priority order of information, that is, which information is to be preferentially displayed is preset on the basis of the size of the display region of each item. The information amount control unit 114 determines information that can be added or information to be deleted as the information alteration amount on the basis of the preset priority order, an amount of alteration in size of a display region, and a width of the display region in the Y-axis direction before alternation.

The information amount control unit 114 outputs the determined information alteration amount to the display instruction unit 115. At this time, the information amount control unit 114 also outputs the amount of alteration in size of a display region acquired from the size control unit 113 to the display instruction unit 115.

The display alteration instruction unit 1152 of the display instruction unit 115 causes the display unit 20 to alter the size of the display region of each item in the list displayed on the display unit 20 on the basis of the amount of alteration in size of the display region of each item in the list calculated by the size control unit 113 in Step ST306 and perform display. Furthermore, the display alteration instruction unit 1152 causes an amount of information to be displayed on the display region of each item in the list to be altered on the basis of the amount of alteration in information on each item in the list determined by the information amount control unit 114 in Step ST307, and performs display (Step ST308).

The rotation acquisition unit 117 acquires the rotation angle of the input unit 30 (Step ST309).

The rotation acquisition unit 117 outputs the acquired rotation angle of the input unit 30 to the cursor control unit 118. Note that the rotation acquisition unit 117 outputs information of a rotation angle “0° ” to the cursor control unit 118 even when the input unit 30 is not rotated.

The cursor control unit 118 calculates a movement amount for moving a cursor position displayed on the display unit 20 on the basis of the rotation angle of the input unit 30 acquired by the rotation acquisition unit 117 in Step ST309 (Step ST310). In the first embodiment, a threshold (hereinafter referred to as a “movement threshold”) of a rotation angle of the input unit 30 for moving the cursor position by one item on the list is preset. The cursor control unit 118 calculates an amount of movement of a cursor position, that is, to which side and by how many items a cursor should be moved on the list on the basis of the preset movement threshold of a rotation angle and the rotation angle of the input unit 30 acquired by the rotation acquisition unit 117.

The cursor control unit 118 outputs the calculated amount of movement of the cursor position to the display instruction unit 115.

The display alteration instruction unit 1152 of the display instruction unit 115 displays the cursor displayed on the display unit 20 at a position to which the cursor has been moved on the basis of the movement amount calculated by the cursor control unit 118 in Step ST310 (Step ST311).

Then, while the user is gripping the input unit 30 (“YES” in Step ST312), that is, while the grip status acquisition unit 116 determines that the user is gripping the input unit 30, the processing returns to Step ST304, and the subsequent processing is repeated.

The user checks the display unit 20, and when the list is optimally displayed, the user determines a desired item among the items displayed in the list by, for example, holding down a button on the input unit 30. Here, the user determines a desired restaurant. Then, for example, information on the determined restaurant is output to a navigation device, a guide route to the determined restaurant is calculated in the navigation device, and the calculated guide route is presented on the display unit 20.

In contrast, when the user releases his/her hand from the input unit 30 (“NO” in Step ST312), the grip status acquisition unit 116 determines that the user is not gripping the input unit 30, and the list display instruction unit 1151 switches display to the normal display (Step ST302).

Note that, although the processing has been described to be performed in the order of Steps ST306 to ST311 in the above-described flowchart of FIG. 3, this is not limitative. For example, the processing of Steps ST309 to ST311 may be performed after Step ST303.

Furthermore, the processing based on position change of the input unit 30 in Steps ST304 to ST308 and the processing based on rotation of the input unit 30 in Steps ST309 to ST311 may be simultaneously performed in parallel.

Here, FIGS. 5A and 5B illustrate one example of images of a list displayed on the display unit 20 in the case where the operations in Steps ST304 to ST311 in FIG. 3 are performed in the first embodiment.

FIG. 5A illustrates one example of images of the display unit 20 in a state where a menu list is displayed on the display unit 20 as a result of the user gripping the input unit 30 and the input unit 30 is at the origin, and FIG. 5B illustrates one example of images of the display unit 20 in a state where the input unit 30 has been moved from the state of FIG. 5A to the right.

Note that a list having the same content as the list displayed on the display unit 20 in FIG. 1 is displayed on the display unit 20 in FIG. 5A.

When the user operates the input unit 30 to the right and the position of the input unit 30 is changed from the state in FIG. 5A (“YES” in Step ST305), the change amount calculation unit 112 calculates an amount of change in position of the input unit 30. Then, the size control unit 113 calculates an amount of alteration in size of a display region on the basis of the amount of change in position of the input unit 30 (Step ST306), and the information amount control unit 114 newly determines information on a route to a restaurant as information that can be added on the basis of the amount of alteration in size of the display region (Step ST307).

Then, as illustrated in FIG. 5B, the display alteration instruction unit 1152 expands the display region of each item in the Y-axis direction from the state in FIG. 5A by the amount of alteration in size of the display region calculated by the size control unit 113, and causes a list, in which, for example, a name of each restaurant, a photograph of each restaurant, and information on a route to each restaurant is displayed, to be displayed (Step ST308).

At this time, the display alteration instruction unit 1152 may expand the display region of each item in the Y-axis direction, and deform the display region. Specifically, for example, as illustrated in FIG. 5B, the display alteration instruction unit 1152 deforms a display region in such a manner that opposite sides, extending in the substantially X-axis direction of the display region, of the display region of each item are mutually inclined to the upper right. This causes the user to easily grasp a changing display mode.

Note that, when the input unit 30 is positioned at the origin, opposite sides, extending in the substantially X-axis direction of the display region, of the display region of each item are parallel to the X-axis (see FIG. 5A). How much the sides extending in the substantially X-axis direction of the display region are inclined is predetermined on the basis of an amount of change in position of the input unit 30 at the time when the input unit 30 is moved from the origin to the right or to the left.

Moreover, the user checks a list displayed on the display unit 20, rotates the input unit 30, and adjusts the cursor position as necessary. Specifically, the rotation acquisition unit 117 acquires a rotation angle of the input unit 30 (Step ST309), and the cursor control unit 118 calculates a movement amount for moving a cursor displayed on the display unit 20 on the basis of the rotation angle (Step ST310). Note that, the cursor position may be indicated by a graphic for pointing the cursor, such as an arrow, being directly displayed on the display unit 20, or by changing the color of the display region of the selected item in the list and performing display. In FIGS. 5A and 5B, in one example, the cursor position is indicated by changing the color of the display region of an item, selected by the cursor, in the list and performing display. That is, for example, in FIG. 5B, the cursor is positioned in the second item (see 501 in FIG. 5B) from the top among the items, displayed on the display unit 20, in the list.

Then, the processing returns to Step ST304 and the subsequent processing is repeated until the grip status acquisition unit 116 determines that the user is not gripping the input unit 30. This enables the display control device 10 to continuously alter the size of the display region of each item and the amount of information to be displayed on the display region in the list displayed on the display unit 20 in response to the change in position of the input unit 30. Specifically, the size control unit 113 continuously calculates an amount of alteration in size of the display region of each item in the list on the basis of the amount of change in position of the input unit 30 (Step ST306), and the information amount control unit 114 determines an information alteration amount on the basis of the size of the display region of each item in the list (Step ST307). Then, the display alteration instruction unit 1152 continuously causes the size of the display region of each item in the list and information amount of information to be displayed on the display region to be altered and performs display on the basis of the amount of alteration in size of the display region of each item in the list calculated by the size control unit 113.

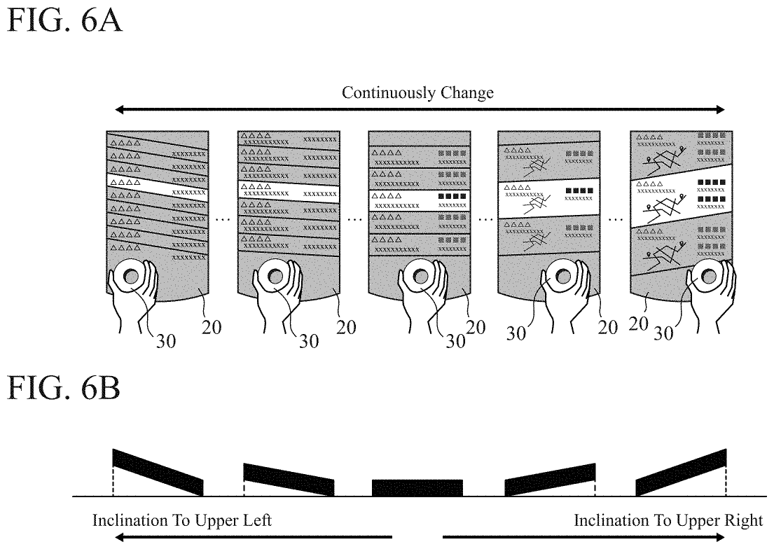

FIGS. 6A and 6B illustrate one example of images of a list displayed on the display unit 20 in the case where the display control device 10 continuously alters the size of a display region for information on each item in the list and the amount of information to be displayed on the display region in response to the change in position of the input unit 30 in the first embodiment. FIG. 6A illustrates an image of one example of specific contents displayed on the display unit 20, and FIG. 6B illustrates an image of the shape of a display region altered along with the size.

Note that, in the description with reference to the flowchart of FIG. 3, a case where the user moves the input unit 30 to the right has been taken as an example, and an operation of the display control device 10 increasing the size of the display region of each item in the list and an information amount by an amount of change in position of the input unit 30 that has been moved to the right has been described. This is one example. For example, when the user operates the input unit 30 to the left, the display control device 10 decreases the size of the display region of each item in the list and an information amount by an amount of change in position of the input unit 30 that has been moved to the left (see FIG. 6A).

Furthermore, as illustrated in FIG. 6A, when the user continuously moves the input unit 30 to the right or left, the display region of each item in the list is continuously deformed on the basis of the amount of change in position of the moved input unit 30. Specifically, for example, when the input unit 30 is continuously moved to the right, the display alteration instruction unit 1152 of the display control device 10 continuously deforms a display region in such a manner that opposite sides, extending in the substantially X-axis direction of the display region, of the display region are mutually inclined to the upper right. In contrast, for example, when the input unit 30 is continuously moved to the left, the display alteration instruction unit 1152 of the display control device 10 continuously deforms a display region in such a manner that opposite sides, extending in the substantially X-axis direction of the display region, of the display region are mutually inclined to the upper left.

At this time, the display alteration instruction unit 1152 deforms the display region in such a manner that the inclination is increased as the amount of change in position of the input unit 30 from the origin is increased (see FIG. 6B). FIG. 6B illustrates one example of images of the inclination of the display region deformed by the display alteration instruction unit 1152. As illustrated in FIG. 6B, the inclination of the side extending in the substantially X-axis direction of the display region is increased as the amount of alteration of the input unit 30 from the origin is increased.

Increasing the degree of deformation of the display region on the basis of the amount of change in position of the input unit 30 from the origin allows the user to grasp the fact that the display mode is continuously changed in response to the movement of the input unit 30.

Furthermore, in the above description, when the size of the display region is increased by the position of the input unit 30 being changed to the right, the information amount control unit 114 determines to add information in descending order of preset priority on the basis of the size. Instead or in addition, the information amount control unit 114 may determine to, for example, enlarge or reduce the size of, for example, a letter or an image, which is already-displayed information, on the basis of the size of the display region.

Specifically, for example, when the information amount control unit 114 determines that there is no additional information to be displayed, notwithstanding that the size of the display region is increased, the amount of information to be displayed on the display region is not altered, and the display alteration instruction unit 1152 may cause the size of, for example, a letter or an image, which is already-displayed information, to be enlarged on the basis of the amount of alteration in size of the display region.

Furthermore, although, in the above description, the display control device 10 continuously changes the size of the display region of each item in the list displayed on the display unit 20 in response to the change in position of the input unit 30 (see FIGS. 6A and 6B), this is not limitative. The display control device 10 can change the size of the display region of each item in the list displayed on the display unit 20 in a limited manner by dividing the size into preset stages in response to the change in position of the input unit 30.

Specifically, for example, the display control device 10 changes the size of the display region in three stages by changing the size of the display region in the case where the input unit 30 is positioned at either of two preset alteration positions. The change amount calculation unit 112 determines whether the input unit 30 is positioned at either of the two preset alteration positions. When determining that the input unit 30 is positioned at either of the two preset alteration positions, the change amount calculation unit 112 determines that the position of the input unit 30 has been changed, and outputs the amount of change in position of the input unit 30 and the information on the position of the input unit 30 to the size control unit 113 (Step ST305).

The size control unit 113 calculates the size of the display region of each item in the list on the basis of the change amount and the information on the position of the input unit 30 output from the change amount calculation unit 112 (Step ST306). Furthermore, the information amount control unit 114 determines the information alteration amount on the basis of the size of the display region of each item in the list (Step ST307).

Then, the display alteration instruction unit 1152 causes the display unit 20 to alter and display the size of the display region of each item in the list and information amount of information to be displayed on the display region in the preset three stages (Step ST308). At this time, the display alteration instruction unit 1152 alters the size of the display region, and deforms the shape of the display region on the basis of the amount of change in position of the input unit 30.

Note that, as described above, the information amount control unit 114 may determine to enlarge or reduce the size of, for example, a letter or an image, which is already-displayed information, on the basis of the amount of alteration in size of the display region in Step ST307. The display alteration instruction unit 1152 may cause the size of, for example, a letter or an image to be enlarged or reduced and displayed in Step ST308.

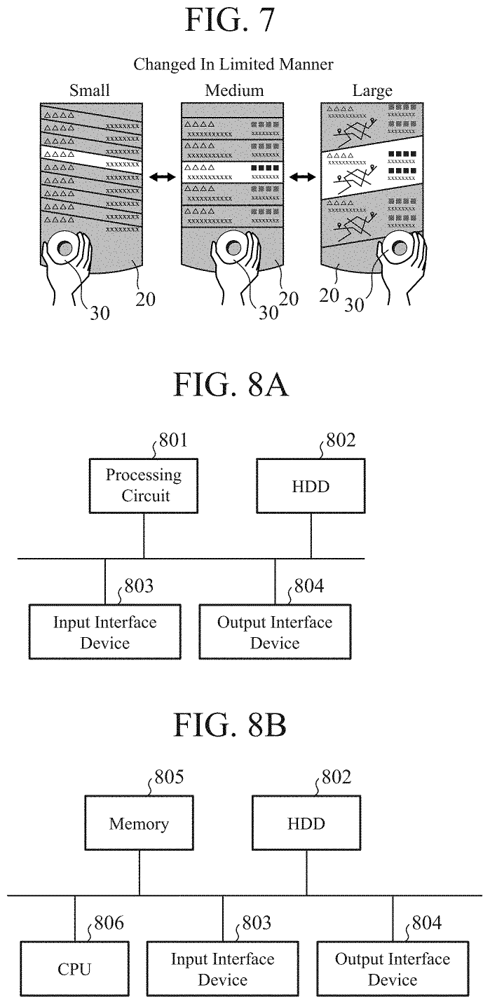

FIG. 7 illustrates one example of images of a list displayed on the display unit 20 in the case where the display control device 10 alters the size of a display region for information on each item in the list and the amount of information to be displayed on the display region in a limited manner in the three stages in response to the change in position of the input unit 30 in the first embodiment.

As illustrated in FIGS. 6A and 6B, when continuously changing the size of the display region for information on each item in the list, the user can finely adjust the size of the display region of each item in the list, and sensuously find the optimum display that suits his/her condition.

In contrast, as illustrated in FIG. 7, when changing the size of the display region for information on each item in the list and an information amount in a limited manner, the user can quickly switch to the optimum display among a plurality of sizes in stages in the case where the user knows the optimum display that suits his/her condition.

In this way, the display control device 10 can alter and display the size of the display region of each item displayed in the list continuously or in a limited manner without needing to switch a screen.

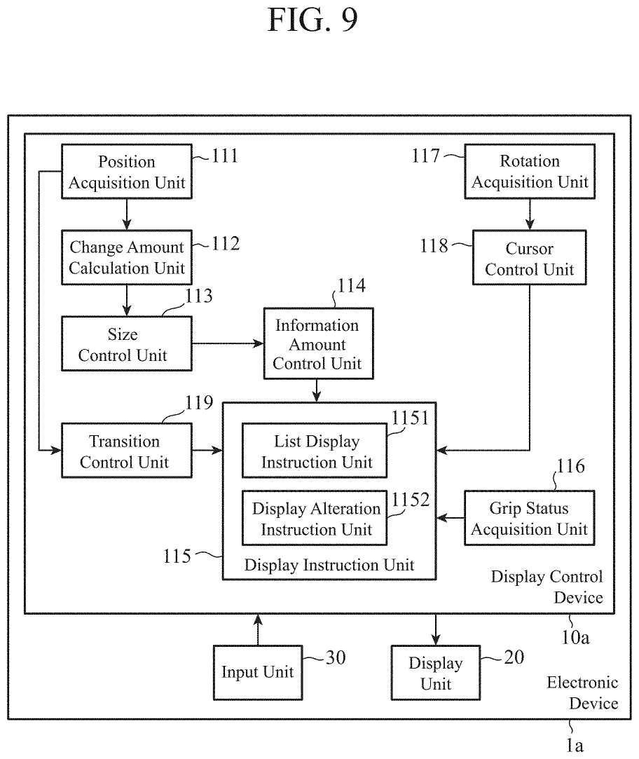

FIGS. 8A and 8B illustrate examples of the hardware configuration of the display control device 10 according to the first embodiment.

In the first embodiment, a processing circuit 801 implements each function of the position acquisition unit 111, the change amount calculation unit 112, the size control unit 113, the information amount control unit 114, the display instruction unit 115, the grip status acquisition unit 116, the rotation acquisition unit 117, and the cursor control unit 118. That is, the display control device 10 includes the processing circuit 801. The processing circuit 801 acquires the current position of the input unit 30, and performs control of altering the size of the display region for information on each item in the list to be displayed and the amount of information to be displayed on the display region on the basis of the acquired current position of the input unit 30.

The processing circuit 801 may be dedicated hardware as illustrated in FIG. 8A, or may be a central processing unit (CPU) 806 that executes a program stored in a memory as illustrated in FIG. 8B.

When the processing circuit 801 is dedicated hardware, the processing circuit 801 is, for example, a single circuit, a composite circuit, a programmed processor, a parallel programmed processor, an application specific integrated circuit (ASIC), a field-programmable gate array (FPGA), or a combination thereof.

When the processing circuit 801 is the CPU 806, software, firmware, or a combination of software and firmware implement each function of the position acquisition unit 111, the change amount calculation unit 112, the size control unit 113, the information amount control unit 114, the display instruction unit 115, the grip status acquisition unit 116, the rotation acquisition unit 117, and the cursor control unit 118. That is, a processing circuit such as the CPU 806 that executes a program stored in, for example, a hard disk drive (HDD) 802 and a memory 805 and a system large-scale integration (LSI) implements the position acquisition unit 111, the change amount calculation unit 112, the size control unit 113, the information amount control unit 114, the display instruction unit 115, the grip status acquisition unit 116, the rotation acquisition unit 117, and the cursor control unit 118. Furthermore, it can be said that a program stored in, for example, the HDD 802 and the memory 805 causes a computer to execute a procedure and a method in the position acquisition unit 111, the change amount calculation unit 112, the size control unit 113, the information amount control unit 114, the display instruction unit 115, the grip status acquisition unit 116, the rotation acquisition unit 117, and the cursor control unit 118. Here, examples of the memory 805 include a non-volatile or volatile semiconductor memory, such as a random access memory (RAM), a read only memory (ROM), a flash memory, an erasable programmable read only memory (EPROM), and an electrically erasable programmable read-only memory (EEPROM), a magnetic disk, a flexible disk, an optical disk, a compact disk, a mini disk, and a digital versatile disc (DVD).

Note that dedicated hardware may implement a part of each function of the position acquisition unit 111, the change amount calculation unit 112, the size control unit 113, the information amount control unit 114, the display instruction unit 115, the grip status acquisition unit 116, the rotation acquisition unit 117, and the cursor control unit 118, and software or firmware may implement a part of each function thereof. For example, the function of the position acquisition unit 111 can be implemented by the processing circuit 801 serving as dedicated hardware. The functions of the change amount calculation unit 112, the size control unit 113, the information amount control unit 114, the display instruction unit 115, the grip status acquisition unit 116, the rotation acquisition unit 117, and the cursor control unit 118 can be implemented by the processing circuit reading and executing a program stored in the memory 805.

Furthermore, the display control device 10 includes an input interface device 803 and an output interface device 804. The input interface device 803 and the output interface device 804 receive or transmit information from/to an external device such as the input unit 30 and the display unit 20. For example, the display control device 10 acquires sensor data from the input unit 30 by using the input interface device 803. Furthermore, for example, the display control device 10 instructs the display unit 20 to display a list by using the output interface device 804.

As described above, according to the first embodiment, the display control device 10 includes: the list display instruction unit 1151 for causing the display unit 20 to display a list of a plurality of items representing information to be provided to a user; the position acquisition unit 111 for acquiring a position of the input unit 30 movably provided on the display unit 20; the size control unit 113 for calculating an amount of alteration in size of a display region of each item in the list displayed on the display unit 20 in response to change in position of the input unit 30 when the position of the input unit 30, which has been acquired by the position acquisition unit 111, is changed; and the display alteration instruction unit 1152 for altering the size of a display region of each item in the list displayed on the display unit 20 on the basis of the amount of alteration in size of the display region of each item, which has been calculated by the size control unit 113. This configuration enables the user to alter the size of the display region of each of a plurality of items displayed in a list with an easy operation. As a result, the user can set the display region to a size suitable for different times.

Furthermore, the display control device 10 includes the information amount control unit 114. The information amount control unit 114 determines an amount of alteration in an amount of information on each item in a list displayed on the display unit 20 on the basis of the amount of alteration in size of the display region of each item, which has been calculated by the size control unit 113. The display alteration instruction unit 1152 alters an information amount in the case of displaying information on each item in the list on the display region of each item in the list on the basis of the amount of alteration in an information amount, which has been determined by the information amount control unit 114. This enables an amount of information displayed on a display region for each of a plurality of items displayed in a list to be altered by the smaller number of operations than in a traditional list display method. As a result, the user can set the information display amount to an amount suitable for different times.

In this way, the user can freely adjust operation feeling suitable for different times while searching the list displayed on the display unit 20 for desired information.

### Second Embodiment

In the first embodiment, when the display control device 10 displays a list on the display unit 20, a user checks the display unit 20, and adjusts, for example, the size of the display region of each item in the list. Then, the user determines a desired item by, for example, holding down a button on the input unit 30.

In a second embodiment, an embodiment in which an item in a list can be determined on the basis of a position of the input unit 30 will be described.

FIG. 9 illustrates one example of the configuration of a display control device 10a according to the second embodiment.

The display control device 10a is different from the display control device 10 described in the first embodiment with reference to FIG. 2 in that the display control device 10a includes a transition control unit 119.

The same signs are attached to other configurations similar to those in the display control device 10 of the first embodiment, and duplicate description is omitted.

Note that the display control device 10a according to the second embodiment is also mounted in, for example, an electronic device la installed in a center console of a vehicle such as an automobile similarly to the display control device 10 according to the first embodiment. The center console is provided in a front part of the vehicle interior. The outline of the electronic device la is similar to the outline of the electronic device 1 described in the first embodiment with reference to FIG. 1, and thus duplicate description thereof is omitted.

Furthermore, the display control device 10a has a hardware configuration similar to that of the display control device 10 described in the first embodiment with reference to FIGS. 8A and 8B, and thus duplicate description thereof is omitted. Similarly to the function of, for example, the position acquisition unit 111, the processing circuit 801 implements the function of the transition control unit 119.

The transition control unit 119 determines whether the input unit 30 in a movable range of the input unit 30 acquired by the position acquisition unit 111 is positioned at a preset operation guide display position (described in detail later) or a preset screen switching position (described in detail later). When determining that the input unit 30 is at the operation guide display position or the screen switching position, the transition control unit 119 outputs information indicating that the input unit 30 is at the operation guide display position or the screen switching position to the display instruction unit 115.

In the display control device 10a of the second embodiment, the position acquisition unit 111 outputs the acquired information on the position of the input unit 30 to the change amount calculation unit 112 and the transition control unit 119.

Furthermore, when the transition control unit 119 outputs the information indicating that the input unit 30 is at the operation guide display position or information indicating that the input unit 30 is at the screen switching position, the display instruction unit 115 causes the display unit 20 to display information based on each position. Details will be described later.

Operations of the display control device 10a of the second embodiment will be described.

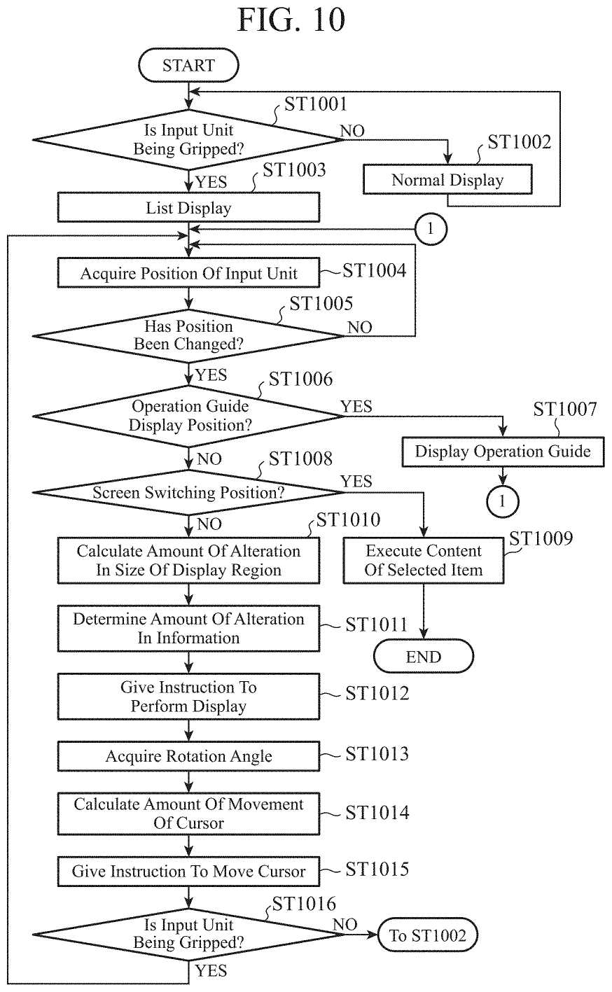

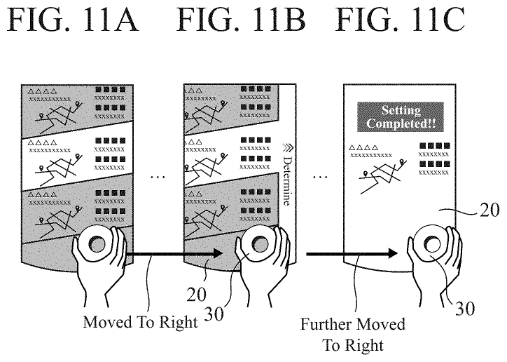

FIG. 10 is a flowchart for describing operations of the display control device 10a of the second embodiment.

In FIG. 10, each of the specific operations of Steps ST1001 to ST1005 and Steps ST1010 to ST1016 are similar to the specific operations of Steps ST301 to ST312 in FIG. 3 described in the first embodiment, and thus duplicate description thereof is omitted.

Hereinafter, specific operations of Steps ST1006 to ST1009 that are different from those in the first embodiment will be described.

When the position acquisition unit 111 acquires the position of the input unit 30 in a movable range of the input unit 30 (Step ST1004), the transition control unit 119 acquires information on the position of the input unit 30 from the position acquisition unit 111, and determines whether the input unit 30 is positioned at a preset operation guide display position (Step ST1006).

The operation guide display position is preset at a pixel position that is closer to the origin by the preset number of pixels than the pixel position of an end of the movable range of the input unit 30. Specifically, the operation guide display position is preset at a position on a coordinate x on the X-axis. The position is closer to the origin by the preset number of pixels than a pixel position having the smallest value of coordinate x. Alternatively, the operation guide display position is preset at a position on a coordinate x on the X-axis. The position is closer to the origin by the preset number of pixels than a pixel position having the largest value of coordinate x.

In relation to the later-described screen switching position, when the operation guide display position is set at the position, on a coordinate x on the X-axis, closer to the origin by the number of set pixels than the pixel position having the smallest value of coordinate x, the screen switching position is set at a position closer to an end having the smallest value of coordinate x than the operation guide display position. In contrast, when the operation guide display position is set at the position, on the coordinate x on the X-axis, closer to the origin by the number of set pixels than the pixel position having the largest value of coordinate x, the screen switching position is set at a position closer to an end having the largest value of coordinate x than the operation guide display position.

When determining that the input unit 30 is at the operation guide display position (“YES” in Step ST1006), the transition control unit 119 outputs information indicating that the input unit 30 is at the operation guide display position to the display instruction unit 115.

Here, the operation guide display position is preset at the position, on the coordinate x on the X-axis, closer to the origin by the number of set pixels than the pixel position having the largest value of coordinate x. For example, the input unit 30 is moved on the display unit 20 in the direction in which the value of coordinate x is increased, from the origin (x=0) to the operation guide display position.

When the transition control unit 119 outputs information indicating that the input unit 30 is at the operation guide display position, the display alteration instruction unit 1152 of the display instruction unit 115 causes the display unit 20 to display a prospective operation content to be executed next as an operation guide (Step ST1007).

FIGS. 11 to 11C illustrate one example of images of a screen on which the display alteration instruction unit 1152 causes the display unit 20 to display the operation guide in the second embodiment.

FIG. 11A illustrates one example of images of a list displayed on the display unit 20 before the input unit 30 is moved to the operation guide display position, and FIG. 11B illustrates one example of images of a screen of the display unit 20 at the time when the input unit 30 is moved from the state illustrated in FIG. 11A to the operation guide display position. FIG. 11C illustrates one example of images of a screen of the display unit 20 at the time when the input unit 30 is further moved from the state illustrated in FIG. 11B to the screen switching position.

When the user moves the input unit 30 from the state in FIG. 11A to the right (direction in which the value of coordinate x is increased) and the input unit 30 arrives at the operation guide display position, the transition control unit 119 outputs information indicating that the input unit 30 is at the operation guide display position to the display instruction unit 115, and the display alteration instruction unit 1152 causes the operation guide to be displayed as illustrated in FIG. 11B. Specifically, for example, the display alteration instruction unit 1152 causes the display unit 20 to display the operation guide at an end outside the operation guide display position. In FIG. 11B, the display alteration instruction unit 1152 causes a region where “determine” is displayed to be displayed at the right end of the display unit 20 as the operation guide (see 1101 in FIG. 11B). This indicates that the prospective operation content to be executed next is “determine” of the content of the item in which the cursor is currently positioned. In this way, the operation guide indicates a prospective operation content to be executed next when the user further moves the input unit 30 from the current position to the right.

That is, the operation guide is display for letting the user know that, when the input unit 30 continues to be further moved, the operation content to be executed next is confirmed and the screen is switched to a screen indicating that the operation content to be executed next is confirmed.

FIG. 11C will be described later, and the description returns to the flowchart of FIG. 10.

When the display instruction unit 115 causes the operation guide as illustrated in FIG. 11B to be displayed in Step ST1007, the processing returns to Step ST1004.

In contrast, when the transition control unit 119 determines that the input unit 30 is not at the operation guide display position in Step ST1006 (“NO” in Step ST1006), the processing proceeds to Step ST1008.

The transition control unit 119 acquires information on the position of the input unit 30 from the position acquisition unit 111, and determines whether the input unit 30 is at a preset display switching position (Step ST1008).

When determining that the input unit 30 is at the display switching position (“YES” in Step ST1008), the transition control unit 119 outputs information indicating that the input unit 30 is at the display switching position to the display instruction unit 115.

Here, for example, the input unit 30 is further moved from the operation guide display position illustrated in FIG. 11B to the right, and to the display switching position.

When the transition control unit 119 outputs information indicating that the input unit 30 is at the display switching position, the display alteration instruction unit 1152 causes the display unit 20 to switch a screen to a confirmation screen for letting the user know that a prospective operation content to be executed next displayed as an operation guide has been confirmed as the operation content to be executed next (Step ST1009). Here, for example, the display alteration instruction unit 1152 causes a screen to be switched to a confirmation screen indicating that determination to execute the content of an item selected by the user, that is, the item in which a cursor is positioned among items in a list has been confirmed.

For example, when the input unit 30 is further moved from the screen as illustrated in FIG. 11B to the right, and arrives at the display switching position, the transition control unit 119 outputs information indicating that the input unit 30 is at the display switching position to the display instruction unit 115. Then, the display alteration instruction unit 1152 switches a screen to the confirmation screen as illustrated in FIG. 11C. The confirmation screen in FIG. 11C is a screen indicating that the determination to execute the content of the item in which the cursor has been positioned in the list illustrated in FIG. 11B has been confirmed as the operation content to be executed next.

Although, in FIG. 11C, the content of the item in which the cursor has been positioned among items in the list and characters “Setting Complete !!” are displayed in the confirmation screen, this is only one example. The display alteration instruction unit 1152 is only required to perform display in the confirmation screen in such a manner that it can be understood that the content of which item among items in the list has been confirmed as the operation content to be executed next.

When the display instruction unit 115 causes the display unit 20 to display the confirmation screen, an execution control unit (not illustrated) performs control so that a processing content based on an item, in which the cursor is positioned, in the list is executed.

Here, the execution control unit transmits information indicating that route guide to a restaurant indicated in the item, in which the cursor is positioned, in the list is executed to a navigation device. The navigation device receives the information transmitted from the execution control unit, and executes the route guide to the corresponding restaurant.

Note that, in the above description, a case where the user operates the input unit 30 to the right is taken as an example, and operations of the display control device 10a has been described. When the input unit 30 is at the operation guide display position on the right of the origin, the display control device 10a displays the operation guide. When the input unit 30 is further moved to the display switching position on the right of the operation guide display position, the display control device 10a displays a determination screen. This is one example. For example, when the user operates the input unit 30 to the left and the input unit 30 is at an operation guide position on the left of the origin, the display control device 10a may display the operation guide. When the input unit 30 is further moved to the display switching position on the left of the operation guide position, the display control device 10a can switch a screen to a screen for letting the user know that a prospective operation content has been determined as the operation content to be executed.

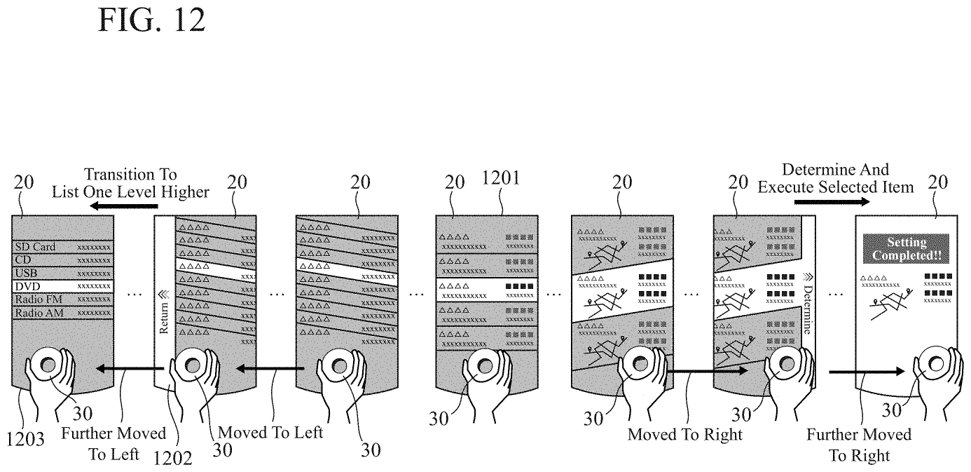

FIG. 12 illustrates one example of screen transition operations performed in the case where the input unit 30 is moved to the left in the second embodiment.

For example, as illustrated in FIG. 12, when a list is displayed on the display unit 20, the user moves the input unit 30 from the state (see 1201 in FIG. 12) where the input unit 30 is at the origin to the left, and the input unit 30 arrives at the operation guide display position, the transition control unit 119 outputs information indicating that the input unit 30 is at the operation guide display position to the display instruction unit 115, and the display alteration instruction unit 1152 causes the operation guide to be displayed. Specifically, for example, the display alteration instruction unit 1152 causes the display unit 20 to display a region where “return” is displayed at an end outside the operation guide display position as the operation guide (see 1102 in FIG. 12). This indicates that the prospective operation content to be executed next is the operation of switching a screen to a screen displaying a list one level higher than the list currently displayed on the display unit 20. Here, for example, a top menu list for the user to display a desired list is preset as the list one level higher than the list displaying recommended restaurants.

Then, when the input unit 30 is further moved from the state where a guide operation is displayed to the left with respect to the display unit 20, and arrives at the display switching position, the transition control unit 119 outputs information indicating the input unit 30 is at the display switching position to the display instruction unit 115. Then, the display alteration instruction unit 1152 causes the display unit 20 to switch a screen to a top menu screen (see 1203 in FIG. 12) on which the above-described top menu list is displayed. The top menu screen lets the user know that “return” has been confirmed as the operation content to be executed.

In this way, the display control device 10a can set a plurality of different prospective operation contents between in the case where the input unit 30 is at the operation guide display position (first operation guide display position) on the right of the origin and in the case where the input unit 30 is at the operation guide display position (second operation guide display position) on the left of the origin. The display control device 10a can indicate the prospective operation content, or confirm the operation content indicated by the prospective operation content on the basis of the position of the input unit 30.

As described above, the display control device 10a can confirm the operation content to be executed next by extending the right and left movement of the input unit 30 in the movable range of the input unit 30. As a result, for example, the user does not need to, for example, separately input an instruction to confirm the execution of the contents of a desired item in the list, and the number of user operations can be reduced.

Note that, although, in the above description, the display alteration instruction unit 1152 causes the prospective operation content to be fixedly displayed as the operation guide in a determined region at the time when the input unit 30 is at the operation guide display position (see FIG. 11B), the display alteration instruction unit 1152 may cause the operation guide to be displayed in stages as the input unit 30 is moved. Specifically, the display alteration instruction unit 1152 causes the display unit 20 to display the operation guide in such a manner that the size of the display region for displaying the operation guide is gradually increased as the input unit 30 is moved from the time when the input unit 30 is positioned at the operation guide display position to the time when the input unit 30 is positioned at the display switching position.

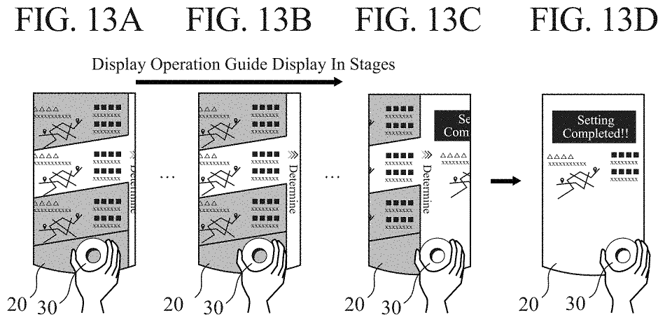

FIGS. 13A to 13D illustrate one example of images of a screen of the display unit 20 in the case where the display alteration instruction unit 1152 causes the operation guide to be displayed in stages in the second embodiment. In FIGS. 13A to 13D, in one example, the input unit 30 is moved to the right in the movable range.

FIG. 13A illustrates one example of images of a screen of the display unit 20 in the case where the input unit 30 is at the operation guide display position. FIGS. 13B and 13C illustrate examples of images of a screen of the display unit 20 in the case where the input unit 30 is positioned between the operation guide display position and the screen switching position. Furthermore, FIG. 13D illustrates one example of images of a confirmation screen in the case where the input unit 30 is at the screen switching position. FIG. 13D illustrates a state similar to that of the display unit 20 described with reference to FIG. 11C.

As illustrated in FIGS. 13A to 13C, the display alteration instruction unit 1152 causes the display unit 20 to display the operation guide in such a manner that the size of the display region for displaying the operation guide is gradually increased as the input unit 30 approaches the screen switching position from the time when the input unit 30 is positioned at the operation guide display position to the time when the input unit 30 is positioned at the screen switching position. Note that the display alteration instruction unit 1152 is required to acquire, for example from the position acquisition unit 111, information on the position of the input unit 30 from the time of acquiring information indicating that the input unit 30 is at the operation guide display position from the transition control unit 119 to the time of acquiring information indicating that the input unit 30 is at the screen switching position.

Then, when determining that the input unit 30 is positioned at the screen switching position, the transition control unit 119 outputs the information indicating the fact to the display instruction unit 115, and the display alteration instruction unit 1152 causes the display unit 20 to display the confirmation screen (FIG. 13D).

In this way, displaying the operation guide in stages enables the user to more sensuously understand the control contents based on the position of the input unit 30, and enables the user to easily understand operations.

As described above, according to the second embodiment, the display control device 10a includes the transition control unit 119 for determining whether the position of the input unit 30 that has been acquired by the position acquisition unit 111 is at the operation guide display position or the screen switching position in addition to the configuration of the display control device 10 of the first embodiment. When the transition control unit 119 determines that the input unit 30 is at the operation guide display position, the display alteration instruction unit 1152 causes the display unit 20 to display the prospective operation content to be executed next. When the transition control unit 119 determines that the input unit 30 is at the screen switching position, the display alteration instruction unit 1152 causes a screen of the display unit 20 to be switched to a screen indicating determination to execute the prospective operation content. As a result, the determination and execution of the content of the operation to be executed next can be determined by extending the movement of the input unit 30.

### Third Embodiment

In the first embodiment, the amount of movement of a cursor for selecting an item in the list is uniform depending on the rotation angle at which the user rotates the input unit 30.

In a third embodiment, an embodiment in which the amount of movement of a cursor can be changed on the basis of the movement of the input unit 30 in the movable range will be described.

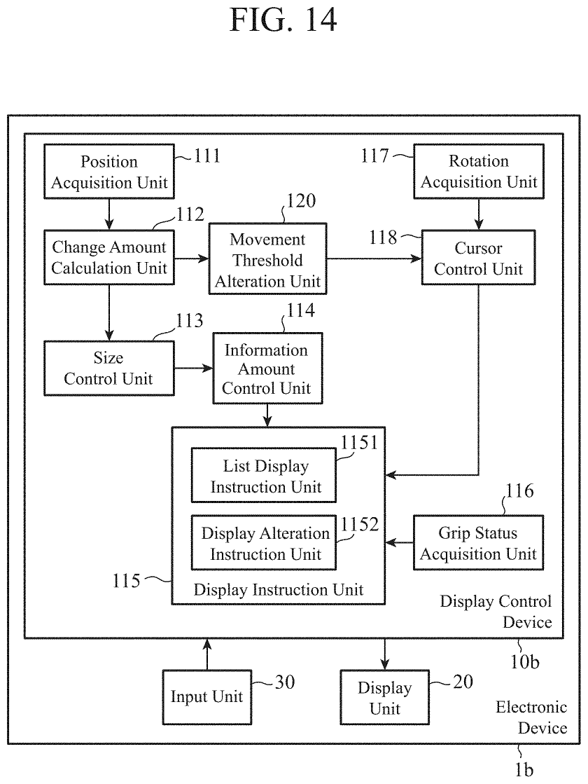

FIG. 14 illustrates one example of the configuration of a display control device 10b according to the third embodiment.

The display control device 10b is different from the display control device 10 described in the first embodiment with reference to FIG. 2 in that the display control device 10b includes a movement threshold alteration unit 120.

The same signs are attached to other configurations similar to those in the display control device 10 of the first embodiment, and duplicate description is omitted.

Note that the display control device 10b according to the third embodiment is also mounted in, for example, an electronic device lb installed in a center console of a vehicle such as an automobile similarly to the display control device 10 according to the first embodiment. The center console is provided in a front part of the vehicle interior. The outline of the electronic device lb is similar to the outline of the electronic device 1 described in the first embodiment with reference to FIG. 1, and thus duplicate description thereof is omitted.

Furthermore, the display control device 10b has a hardware configuration similar to that of the display control device 10 described in the first embodiment with reference to FIGS. 8 A and 8B, and thus duplicate description thereof is omitted. Similarly to the function of, for example, the position acquisition unit 111, the processing circuit 801 implements the function of the movement threshold alteration unit 120.

The movement threshold alteration unit 120 acquires information on an amount of change in position of the input unit 30 from the change amount calculation unit 112, and alters the movement threshold of a rotation angle for calculating an amount of movement of a cursor displayed on the display unit 20 on the basis of the amount of change in position of the input unit 30 calculated by the change amount calculation unit 112.

The movement threshold alteration unit 120 outputs the altered movement threshold to the cursor control unit 118.

In the display control device 10b of the third embodiment, the change amount calculation unit 112 outputs information on the calculated amount of change in position of the input unit 30 to the size control unit 113 and the movement threshold alteration unit 120.

Furthermore, the cursor control unit 118 calculates the amount of movement of a cursor on the basis of the information of the angle of rotation of the input unit 30 acquired by the rotation acquisition unit 117 and the changed movement threshold changed by the movement threshold alteration unit 120.

Operations of the display control device 10b of the third embodiment will be described.

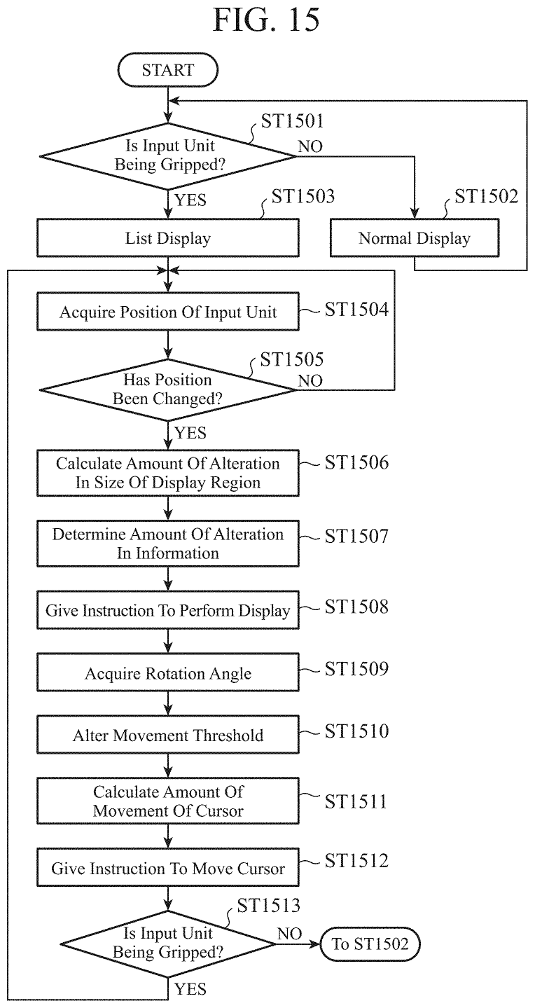

FIG. 15 is a flowchart for describing operations of the display control device 10b of the third embodiment.

In FIG. 15, each of the specific operations of Steps ST1501 to ST1509 and Steps ST1511 to ST1513 are similar to the specific operations of Steps ST301 to ST312 in FIG. 3 described in the first embodiment, and thus duplicate description thereof is omitted.

A specific operation of Step ST1510 that is different from that in the first embodiment will be described below.

The movement threshold alteration unit 120 acquires information on an amount of change in position of the input unit 30 calculated by the change amount calculation unit 112 in Step ST1504, and alters the movement threshold for calculating an amount of movement of a cursor on the basis of the amount of change in position of the input unit 30 (Step ST1510).

Specifically, when the amount of change in position of the input unit 30 is “+”, the movement threshold alteration unit 120 increases the movement threshold on the basis of the change amount. In contrast, when the amount of change in position of the input unit 30 is “−”, the movement threshold alteration unit 120 decreases the movement threshold on the basis of the change amount. Note that it is preset how much the movement threshold alteration unit 120 should increase the movement threshold in accordance with each change amount or inversely decrease the movement threshold with respect to each change amount.

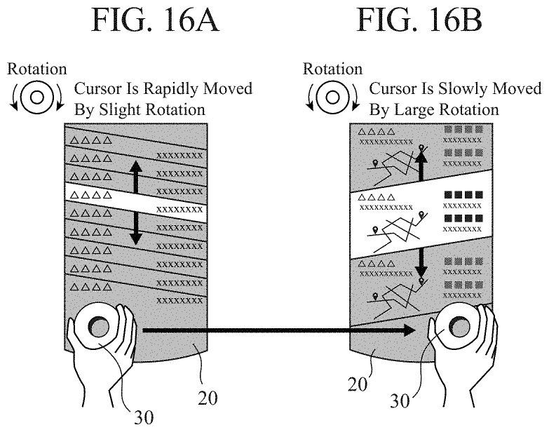

FIGS. 16A and 16B illustrate an image of an operation in which the cursor is moved in the amount of movement of a cursor calculated by the cursor control unit 118 on the basis of the movement threshold changed by the movement threshold alteration unit 120 in the third embodiment. Note that, in FIGS. 16A and 16B, the position of the cursor is indicated by changing the color of the display region of an item, selected by the cursor, in the list and performing display.

FIG. 16A illustrates one example of images of cursor movement in the case where the cursor is moved in a state where the input unit 30 is moved from the origin to the left. FIG. 16B illustrates one example of images of cursor movement in the case where the cursor is moved in a state where the input unit 30 is moved from the state in FIG. 16A to a position on the right of the origin.

In FIG. 16A, the amount of change in position of the input unit 30 is “−”. Consequently, the movement threshold alteration unit 120 alters the movement threshold so that the movement threshold is smaller than that before the alteration. As a result, the cursor is moved to point to each item in the list by slight rotation of the input unit 30.

In contrast, in FIG. 16B, the amount of change in position of the input unit 30 is “+”. Consequently, the movement threshold alteration unit 120 alters the movement threshold so that the movement threshold is larger than that before the alteration. As a result, as compared to the case in FIG. 16A, as the position of the input unit 30 is moved to the right, the cursor does not move unless the input unit 30 is significantly rotated. That is, the cursor is moved more slowly in response to rotation of the input unit 30 in FIG. 16B than in FIG. 16A.

When the movement speed of the cursor is uniform before and after alteration of the size of a display region in the case where the size of the display region of each item in the list is changed, the user has impaired operation feeling. For example, when the movement threshold is set large in the case where the display region of each item in the list has a small size, the user needs to rotate the input unit 30 more for moving the cursor to a distant item in the list, for example. In contrast, when the movement threshold is set small, when the display region of each item in the list has a large size, the cursor may go too far in spite that the user has intended to move the cursor to the item immediately below on the list.

In order to solve the problem, in the display control device 10b of the third embodiment, the movement threshold alteration unit 120 alters the movement threshold on the basis of the amount of change in position of the input unit 30, as described above.

As a result, the operation feeling of the user for the input unit 30 can be optimized in response to change in size of the display region of each item in the list and in information amount of information to be displayed on the display region, and the user can comfortably operate the input unit 30.

As described above, according to the third embodiment, the input unit 30 is rotatable for moving a cursor displayed on the display unit 20, there are provided: the rotation acquisition unit 117 for acquiring a rotation angle of the input unit 30; the movement threshold alteration unit 120 for altering a movement threshold of a rotation angle for calculating an amount of movement of the cursor in response to change in position of the input unit 30; and the cursor control unit 118 for calculating the amount of movement of the cursor on the basis of the rotation angle acquired by the rotation acquisition unit 117 and the movement threshold that has been altered by the movement threshold alteration unit 120, and the display alteration instruction unit 1152 causes the cursor to be displayed at a position to which the cursor has been moved on the basis of a movement amount that has been calculated by the cursor control unit 118. With this configuration, the operation feeling of the user for the input unit 30 can be optimized in response to change in size of the display region of each item in the list and in information amount of information to be displayed on the display region, and the user can comfortably operate the input unit 30.

Note that, although, in the above description of the third embodiment, the operation of the movement threshold alteration unit 120 altering the movement threshold in Step ST1510 is performed after Step ST1509 in FIG. 15, this is not limitative, and the operation of Step ST1510 may be performed at appropriate timing until Steps ST1505 to ST1511.

Furthermore, in the above description of the third embodiment, the third embodiment is applied to the first embodiment, and the display control device 10b includes the movement threshold alteration unit 120 in the display control device 10 of the first embodiment.

This is, however, not limitative. The third embodiment may be applied to the second embodiment, and the display control device 10b may include the movement threshold alteration unit 120 in the display control device 10a described in the second embodiment with reference to FIG. 9.

Furthermore, in the above-described first to third embodiments, the size control unit 113 calculates an amount of alteration in size of a display region of each item in a list displayed on the display unit 20 on the basis of the change amount calculated by the change amount calculation unit 112.

This is, however, not limitative. The size control unit 113 may calculate an amount of alteration in size of a display region of each item in the list displayed on the display unit 20 on the basis of the position of the input unit 30. The size control unit 113 is only required to acquire the position of the input unit 30 from the position acquisition unit 111.

It is predetermined, in the case where at which position in the movable range the input unit 30 is, how much the size of the display region of each item is altered.

In this case, the display control devices 10, 10a, and 10b are not required to include the change amount calculation unit 112.

Furthermore, in this case, the movement threshold alteration unit 120 alters the movement threshold of a rotation angle for calculating the amount of movement of the cursor displayed on the display unit 20 on the basis of the position of the input unit 30 in the third embodiment. The movement threshold alteration unit 120 is only required to acquire the position of the input unit 30 from the position acquisition unit 111.

It is predetermined, in the case where at which position in the movable range the input unit 30 is, how large the movement threshold of a rotation angle is set.

Furthermore, although, in the above-described first to third embodiments, the input unit 30 is linearly moved to the right and left with respect to the display unit 20 in the movable range, the movement locus along which the rotation center of the input unit 30 passes is not limited to a straight line. The movement locus along which the rotation center of the input unit 30 passes may be, for example, an arc. Furthermore, a structure for regulating movement of the input unit 30, such as the slide guide unit, is not necessarily required to be provided. The input unit 30 may be made to freely move on the display unit 20.

Furthermore, although, in the above-described first to third embodiments, in one example, a menu list, which is created after narrowing the pieces of information on recommended restaurants on a guide route to be used by a user down to several pieces of information by using AI, is displayed as a list displayed in the case where the user grips the input unit 30, this is only one example. For example, in the case where the user does not arrive at the place set by the user as a destination within a set period of time, a menu list created by narrowing alternative destinations down to several destinations may be displayed as a list to be displayed in the case where the user grips the input unit 30. Information to be listed and provided to the user can be appropriately set. Various lists can be appropriately displayed on the display unit 20.

Furthermore, the user may narrow down desired items in order from the top menu screen without adopting AI.

In that case, specifically, when the user grips the input unit 30, the list display instruction unit 1151 acquires information indicating that the user has gripped the input unit 30 from the grip status acquisition unit 116. The list display instruction unit 1151 first causes the display unit 20 to display the top menu list, which is data at the highest level, as illustrated in 1203 in FIG. 12. The user moves a cursor to a desired item, and selects the desired item from the top menu list displayed on the top menu screen by, for example, holding down a button set by the input unit 30. The display alteration instruction unit 1152 displays a list in which information on an item desired by the user is displayed. Then, the user appropriately moves the input unit 30 to the right and left to a position where a desired amount of information is obtained.

Note that, within the scope of the invention, the invention of the application can have freely combined embodiments, variations of any component in each embodiment, or omissions of any component in each embodiment.

### INDUSTRIAL APPLICABILITY

A display control device according to the invention can alter the size of the display region of each of a plurality of items displayed in a list with the small number of operations. As a result, the display control device can be applied to a display control device that is mounted in, for example, an electronic device installed in a center console of a vehicle such as an automobile, and that causes a display unit to display information to be presented to a user in a list. The center console is provided in a front part of the vehicle interior.

### REFERENCE SIGNS LIST

1, 1a, 1b: Electronic device, 10, 10a, 10b: Display control device, 20: Display unit, 30: Input unit, 111: Position acquisition unit, 112: Change amount calculation unit, 113: Size control unit, 114: Information amount control unit, 115: Display instruction unit, 116: Grip status acquisition unit, 117: Rotation acquisition unit, 118: Cursor control unit, 119: Transition control unit, 120: Movement threshold alteration unit, 801: Processing circuit, 802: HDD, 803: Input interface device, 804: Output interface device, 805: Memory, 806: CPU, 1151: List display instruction unit, 1152: Display alteration instruction unit.

1. A display control device comprising:
processing circuitry to
cause a display to display an at-a-glance list including a plurality of items representing information to be provided to a user;
acquire a position of an input unit movably provided on the display;
calculate an amount of alteration in size of a display region of each item in the list displayed on the display in response to change in position of the input unit when the acquired position of the input unit is changed;
alter the size of a display region of each item in the list displayed on the display on a basis of the calculated amount of alteration in size of the display region of each item; and
determine whether the acquired position of the input unit is at an operation guide display position,
wherein, when the processing circuitry determines that the input unit is at the operation guide display position, the processing circuitry causes the display to display a prospective operation content to be executed next.

2. The display control device according to claim 1,
wherein the processing circuitry further calculates an amount of change in position of the input unit when the acquired position of the input unit is changed,
wherein the processing circuitry calculates an amount of alteration in size of a display region of each item in the list displayed on the display on a basis of the calculated change amount.

3. The display control device according to claim 1,
wherein, when the acquired position of the input unit is changed, the processing circuitry calculates an amount of alteration in size of a display region of each item in the list displayed on the display on a basis of the position of the input unit.

4. The display control device according to claim 1,
wherein the processing circuitry further determines an amount of alteration in an amount of information on each item in the list displayed on the display on a basis of the calculated amount of alteration in size of the display region of each item,
wherein the processing circuitry alters an information amount in a case of displaying information on each item in the list on the display region of each item in the list on a basis of the determined amount of alteration in the information amount.

5. The display control device according to claim 1,
wherein the processing circuitry continuously calculates an amount of alteration in size of a display region of each item in the list displayed on the display in response to change in position of the input unit.

6. The display control device according to claim 1,
wherein the processing circuitry calculates, in stages, an amount of alteration in size of a display region of each item in the list displayed on the display in response to change in position of the input unit.

7. The display control device according to claim 1,
wherein the processing circuitry determines whether the acquired position of the input unit is at a screen switching position farther than the operation guide display position when viewed from a midpoint position in a movable range of the input unit, and
when the processing circuitry determines that the input unit is at the screen switching position, the processing circuitry switches a screen of the display to a screen indicating determination of execution of the prospective operation content.

8. The display control device according to claim 1,
wherein the operation guide display position includes a first operation guide display position and a second operation guide display position, and
the processing circuitry causes different prospective operation content to be displayed between in a case where the processing circuitry determines that the input unit is at the first operation guide display position and in a case where the processing circuitry determines that the input unit is at the second operation guide display position.

9. The display control device according to claim 1,
wherein the processing circuitry causes display to be performed in such a manner that a size of a region for displaying the prospective operation content is gradually increased on a basis of the position of the input unit.

10. The display control device according to claim 1,
wherein the input unit is rotatable for moving a cursor displayed on the display,
the processing circuitry further
acquires a rotation angle of the input unit;
alters a movement threshold of a rotation angle for calculating an amount of movement of the cursor in response to change in position of the input unit; and
calculates the amount of movement of the cursor on a basis of the acquired rotation angle and the altered movement threshold, and
the processing circuitry causes the cursor to be displayed at a position to which the cursor has been moved on a basis of the calculated movement amount.

11. The display control device according to claim 1,
wherein the processing circuitry further
acquires information on whether the input unit has detected a hand of a user,
wherein, when the processing circuitry acquires information that the input unit has detected the hand of the user, the processing circuitry causes the display to display the list, and
when the processing circuitry acquires information that the input unit has not detected the hand of the user, the processing circuitry causes the display to display information other than the list.

12. The display control device according to claim 1,
wherein a movement direction of the input unit for altering a size of a display region of each item in the list and an alteration direction in which the processing circuitry alters the size of a display region of each item in the list are orthogonal on the display.

13. A display control method comprising:
causing a display to display an at-a-glance list including a plurality of items representing information to be provided to a user;
acquiring a position of an input unit movably provided on the display;
calculating an amount of alteration in size of a display region of each item in the list displayed on the display in response to change in position of the input unit when the acquired position of the input unit is changed;
altering the size of a display region of each item in the list displayed on the display on a basis of the amount of alteration in size of the display region of each item, which has been calculated by the size control unit;
determining whether the acquired position of the input unit is at an operation guide display position; and
causing the display to display a prospective operation content to be executed next when determining that the input unit is at the operation guide display position.

14. A non-transitory computer readable recording medium having stored thereon a display control program to be executed on a computer, the display control program causing the computer to perform:
displaying an at-a-glance list including a plurality of items representing information to be provided to a user on a display;
acquiring a position of an input unit movably provided on the display;
calculating an amount of alteration in size of a display region of each item in the list displayed on the display in response to change in position of the input unit when the position of the input unit is changed;
altering the size of a display region of each item in the list displayed on the display on a basis of the calculated amount of alteration in size of the display region of each item;
determining whether the acquired position of the input unit is at an operation guide display position; and
displaying a prospective operation content to be executed next on the display when the input unit is determined to be at the operation guide display position.

15. An electronic device comprising:
the display control device according to claim 1;
the display; and
the input unit.
